(19) United States
(12) Patent Application Publication
(10) Pub. No.: US 2022/0207250 A1
(43) Pub. Date: Jun. 30, 2022

(54) RFID TAG QUANTITY ESTIMATION SYSTEM, RFID TAG QUANTITY ESTIMATION METHOD, AND PROCESSOR-READABLE MEDIUM

(71) Applicant: SOOCHOW UNIVERSITY, Suzhou (CN)

(72) Inventors: Zhe LI, Suzhou (CN); Wei DENG, Suzhou (CN)

(21) Appl. No.: 17/437,590

(22) PCT Filed: Mar. 9, 2021
(86) PCT No.: PCT/CN2021/079839

§ 371 Date: Sep. 9, 2021

(30) Foreign Application Priority Data
Apr. 27, 2020 (CN) 202010342199.1

(51) Int. Cl. G06K 7/10; G06K 9/62; G06K 19/07

(52) U.S. Cl. CPC G06K 7/10069; G06K 19/0723; G06K 9/6232; G06K 7/10366

(57) ABSTRACT

This application discloses a tag quantity estimation system and method of RFID. A processor-readable medium was disclosed at the same time. This estimation method applies a spatial diversity gain existing in a multi-antenna system. Separated and sequentially stacked the real parts and the imaginary parts of the multiple signals received by multiple antennas. Then, a tag quantity estimation problem is converted into a data clustering problem in high-dimensional space. In this way, the overlapped cluster data in low-dimensional space can be separated in the high-dimensional space, thereby improving the accuracy of tag quantity estimation.

### TECHNICAL FIELD

This application relates to signal processing technologies, and specifically, to an ultra-high frequency RFID tag quantity estimation system based on high-dimensional space, an ultra-high frequency RFID tag quantity estimation method based on high-dimensional space, and a processor-readable medium.

### BACKGROUND

In recent years, RF identification technology has been successfully applied in many different fields such as warehouse inventory, asset tracking, and personal identification. In a typical multi-tag ultra-high frequency (UHF) RFID system, different passive tags can simultaneously reverse scatter their information. As a result, signals of the tags interfere with each other. This phenomenon, commonly known as tag collision, has a significant impact on the decreased access efficiency of the RFID system.

A common solution to this problem in various RFID standards such as ISO18000-6C is the Random Access Algorithm based on the framed slot (Framed Slot Aloha, FSA). Previous studies show that in RFID system based on FSA access protocol, the system can obtain the maximum throughput when the frame length is equal to the number of tags to be accessed. However, in an actual scenario, since the number of tags to be accessed is usually not known in advance, the RFID system based on the FSA access protocol rarely works in optimal state.

To solve this problem, existing work has proposed a series of algorithms for single-antenna RFID systems. For example, the slot state detection algorithm (SSDA) projects the received signal into the I-Q complex plane and estimates the quantity of signal clusters in the I-Q complex plane. Estimates of the quantity of tags are given based on the relationship between the quantity of clusters and the quantity of tags. Furthermore, there are also algorithms based on the statistical properties of the histogram (Histogram) to detect the existence of multiple tags and to determine the quantity of tags. Although these methods work well in a real-time system, their performance greatly deteriorates at a low signal-to-noise ratio (SNR). On the other hands, multi-antenna RFID systems have been widely used in recent years. A typical solution to estimating the quantity of tags under a multi-antenna system is to first perform the antenna selection (Antenna Selection, AS) algorithm to obtain higher signal-to-noise ratios, and then estimate the quantity of tags using the SSDA algorithm or Histogram algorithm. However, this scheme is sub-optimal because it employs only the information received by one antenna while discarding useful information on the other receiving antennas.

Therefore, a new ultra-high frequency RFID tag quantity estimation method is required.

### SUMMARY

In view of the existing art defects, in a multi-antenna RFID environment, the objective of this application is to propose an ultra-high frequency RFID tag quantity estimation method based on high-dimensional space. In this estimation method, a spatial diversity gain existing in a multi-antenna system is used, and signals received by multiple antennas are re-arranged to high-dimensional vectors. So, a tag quantity estimation problem is modeled as a data clustering problem in high-dimensional space. In this way, overlapped cluster data in low-dimensional space can be separated in the high-dimensional space, thereby improving the accuracy of tag quantity estimation.

For the above purpose, the present application adopts the following technical solutions:

The embodiments of this application provide an RFID tag quantity estimation system, including:

a down-conversion module for down-converting RF signals received by the receiving antenna to the baseband;

a carrier offset module for offsetting the carrier signal in the received signal which is sent by the transmitting antenna; and

a tag quantity estimation module for estimating the quantity of tags, in this way, overlapped cluster data in low-dimensional space can be separated in the high-dimensional space, thereby improving the accuracy of tag quantity estimation.

The embodiments of this application provide an estimation method for an RFID tag quantity estimation system,

where the method includes the following steps:

S0: obtaining multiple information blocks of multiple tag signal responses as reference data for tag quantity estimation;

S1: converting the received RF signals to baseband based on the down-conversion module;

S2: digitalizing the baseband signal and removing the carrier components in the digitalized baseband signal based on a carrier cancellation module; and

S3: estimating the quantity of tags based on a tag quantity estimation module, including:

determining whether the quantity of tags is 0; and

if yes, return to step S0; or

if not, performing step S31, where

sₖ(n)=[s_{1,k}(n),s_{2,k}(n), . . . ,s_{N}_{ᵣ}_{,k}(n)]^{T}, denoting a vector of a k^{th} tag symbol that is received by multiple antennas and in which the carrier signal is removed. The real part and the imaginary part of k are separately extracted. The real part and the imaginary part of the signal are sequentially stacked,

$${\overline{s}}_{k} ( n ) = [ \begin{matrix}ℛ \{ {s}_{k} ( n ) \} \\ 𝒯 \{ {s}_{k} ( n ) \}\end{matrix} ] ,$$

denoting a stacked signal vector, where [symbol] {●} denotes the operation of obtaining real part of a complex number, and ℑ{●} denotes the operation of obtaining imaginary part of a complex number,

S={s̅₁(n),s̅₂(n), . . . ,s̅_{K}(n)}, denoting set of signal sample consisting of multiple received tag symbols.

The DB SCAN algorithm is executed to perform cluster classification on the samples in S, and

statistics on the quantity C of clusters after the classification, and a quantity of tags is calculated, where a calculation method is Nₜ=┌log₂ C┐, where ┌ ┐ denotes rounding up.

Furthermore, ε and M denote a distance parameter and a density parameter respectively in the DBSCAN algorithm, set M=4 and P₀=0.9. The distance parameter ε in the DBSCAN algorithm is calculated through Nᵣ, N₀, and P₀, where a calculation formula is as follows:

ε=2\sqrt{N₀γ⁻¹[Γ(Nᵣ),P₀]}; where

γ⁻¹(m,n) is an inverse function of an incomplete gamma function γ(m,n)=∫₀ⁿt^{m-1}e^{-t}dt, Γ(a)=∫₀^{∞}t^{a-1}e^{-t}dt is a standard gamma function, P₀ denotes a probability specified by a user, Nᵣ denotes the quantity of receive antennas, and N₀ denotes the thermal noise energy.

The embodiments of this application provide an estimation method for an RFID tag quantity estimation system, where

the method includes the following steps:

S1: converting the received RF signals to baseband based on the down-conversion module;

S2: digitalizing the baseband signal and removing the carrier components in the digitalized baseband signal based on a carrier cancellation module; and

S3: estimating the quantity of tags based on a tag quantity estimation module.

In an implementation, the method includes S0 before step S1: obtaining multiple information blocks of multiple tag signal responses as reference data for tag quantity estimation.

In an implementation, step S3 includes: sₖ(n)=[s_{1,k}(n),s_{2,k}(n), . . . ,s_{N}_{ᵣ}_{,k}(n)]^{T}, denoting a vector of the k^{th} tag symbol received by multiple antennas after eliminating the carrier signal.

In an implementation, step S3 further includes: determining whether the quantity of tags is 0; and

if yes, return to step S0; or

if not, performing step S31, where

The real part and the imaginary part of sₖ(n) are separately extracted. The real part and the imaginary part of the signal are sequentially stacked,

$${\overline{s}}_{k} ( n ) = [ \begin{matrix}ℛ \{ {s}_{k} ( n ) \} \\ 𝒯 \{ {s}_{k} ( n ) \}\end{matrix} ] ,$$

denoting a stacked signal vector, where [symbol] {●} denotes the operation of obtaining real part of a complex number, and ℑ{●} denotes the operation of obtaining imaginary part of a complex number.

In an implementation, step S3 further includes:

S={s̅₁(n),s̅₂(n), . . . ,s̅_{K}(n)}, denoting a set of signal sample set consisting of multiple received tag symbols, where

Nᵣ denotes a quantity of receiving antennas, N₀ denotes the thermal noise energy, P₀ denotes a probability specified by a user, and ε and M denote the distance parameter and the density parameter in the DBSCAN algorithm. Step S3 further includes:

M=4 and P₀=0.9, and calculating a distance parameter ε in a DBSCAN algorithm through Nᵣ, N₀, and P₀, where

a calculation formula is as follows:

ε=2\sqrt{N₀γ⁻¹[Γ(Nᵣ),P₀]}; where

γ⁻¹(m,n) is an inverse function of an incomplete gamma function γ(m,n)=∫₀ⁿt^{m-1}e^{-t}dt, Γ(a)=∫₀^{∞}t^{a-1}e^{-t}dt is a standard gamma function, and P₀ denotes a probability specified by a user.

In an implementation, the DBSCAN algorithm is performed to cluster classify the samples in S.

In an implementation, statistics on the quantity C of clusters after the classification, and a quantity Nₜ of tags is calculated, where a calculation method is:

Nₜ=┌log₂ C┐; where

┌ ┐ denotes rounding up.

The embodiments of this application also provide a computer storage medium comprising a computer program that runs the above-described estimation method.

Compared with the solutions in the prior art, the advantages of this application are as follows:

In the RFID tag quantity estimation method provided in this application, the cluster data overlapping in low-dimensional space can be separated in the high-dimensional space, thereby improving the accuracy of tag quantity estimation. The implementation method has more obvious performance advantages when a quantity of antennas increases. In addition, when the quantity of antennas increases, the amount of calculation added is not large.

### BRIEF DESCRIPTION OF DRAWINGS

To describe the technical solutions in the embodiments of this specification or the technical solution in the prior art more clearly, the following drawings briefly describe the embodiments or the technical solution in the prior art. Apparently, the drawings in the following description show merely some embodiments recorded in this specification, and a person of ordinary skill in the art may still derive other drawings from these drawings without paying creative efforts.

FIG. 1 is a schematic diagram of a multi-antenna ultra-high frequency RFID system with one transmitting antenna and multiple receiving antennas according to an embodiment of this application;

FIG. 2 is a signal processing flow block diagram o of an “ultra-high frequency RFID tag quantity estimation method based on high-dimensional space” according to an embodiment of this application; and

FIG. 3 is a simulation schematic diagram of comparison between a method in an embodiment of this application and an existing method.

### DETAILED DESCRIPTION OF EMBODIMENTS

The above solutions are further described below with reference to specific embodiments. It should be understood that these embodiments are used to illustrate this application and are not intended to limit the scope of this application. Implementation conditions used in the embodiments may be further adjusted according to conditions of specific manufacturers, and the unspecified implementation conditions are usually those conditions in routine experiments. To better illustrate the present disclosure, numerous specific details are provided in specific implementations below. Those skilled in the art should understand that the present disclosure may also be implemented without some specific details. In some examples, methods, means, elements, and circuits well-known to those skilled in the art are not described in detail to highlight the gist of the present disclosure.

This application provides an ultra-high frequency RFID tag quantity estimation method (estimation method) based on high-dimensional space. This estimation method applies a spatial diversity gain existing in a multi-antenna system. Signals received by multiple antennas are re-arranged to high-dimensional vectors. Therefore, a tag quantity estimation problem is modeled as a data clustering problem in high-dimensional space. In this way, overlapped cluster data in low-dimensional space can be separated in the high-dimensional space, thereby improving the accuracy of tag quantity estimation. Numerical simulations based on MATLAB demonstrate that the proposed method has great advantages over the existing tag quantity estimation method.

The tag quantity estimation method proposed in this application is described below with reference to the accompanying drawings.

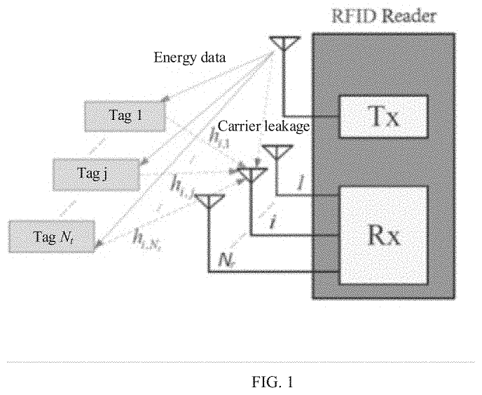

FIG. 1 shows a multi-antenna ultra-high frequency RFID system with one transmitting antenna and multiple receiving antennas according to an embodiment of this application. The system includes one card reader and Nₜ tags, where the card reader is equipped with one transmitting antenna and Nᵣ receiving antennas.

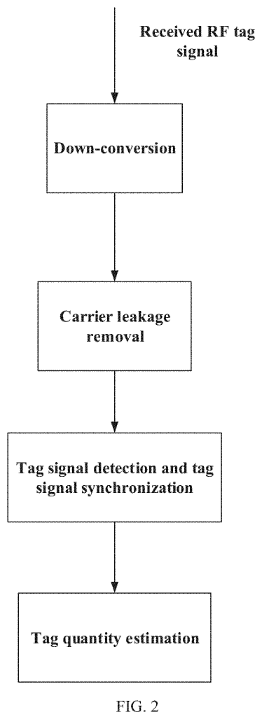

FIG. 2 is a systematic block diagram of an ultra-high frequency RFID tag quantity estimation method based on high-dimensional space.

The RFID tag quantity estimation system includes:

a radio frequency signal down-conversion module for down-converting RF signals received by the receiving antenna to the baseband;

a carrier offset module for offsetting the carrier signal in the received signal which is sent by the transmitting antenna; and

a tag quantity estimation module for estimating the quantity of tags, for example, execute the DBSCAN algorithm to perform cluster classification on samples when it is determined that the quantity of tags is not 0, collect statistics on a quantity C of clusters after classification, and calculate a quantity Nₜ of tags.

When the RFID tag quantity estimation system runs, the tag quantity estimation method (sometimes also referred to as a restoration method) includes:

Step S0: Obtain multiple information blocks of multiple tag signal responses as data for tag quantity estimation. Then, perform step S1.

Step S1: Down-converting the received RF signals to the baseband. Then, perform step S2.

Step S2: Digitalize the baseband signal, and estimate and remove the carrier components in the digitalized baseband signal. Then, perform step S3.

Step S3: Determine whether the quantity of tags is 0; and

if yes, return to step S0; or

if not, perform step S31, where

sₖ(n)=[s_{1,k}(n),s_{2,k}(n), . . . ,s_{N}_{ᵣ}_{,k}(n)]^{T}, denoting a vector of a k^{th} tag symbol that is received by multiple antennas and in which the carrier signal is removed. The real part and the imaginary part of sₖ(n) are separately extracted. The real part and the imaginary part of the signal sequentially stacked,

$${\overline{s}}_{k} ( n ) = [ \begin{matrix}ℛ \{ {s}_{k} ( n ) \} \\ 𝒯 \{ {s}_{k} ( n ) \}\end{matrix} ] ,$$

denoting a stacked signal vector, where [symbol] {●} denotes the operation of obtaining real part of a complex number, and ℑ{●} denotes the operation of obtaining imaginary part of a complex number,

S={s̅₁(n),s̅₂(n), . . . s̅_{K}(n)}, denoting set of signal sample consisting multiple received tag symbols, where Nᵣ denotes the quantity of receive antennas, N₀ denotes the thermal noise energy, P₀ denotes a probability specified by a user, and ε and M denote a distance parameter and a density parameter respectively in the density-based spatial clustering of applications with noise (DBSCAN) algorithm. In this implementation, M=4 and P₀=0.9, and the distance parameter ε in the DB SCAN algorithm is calculated through Nᵣ, N₀, and P₀, where

a calculation formula is as follows:

ε=2\sqrt{N₀γ⁻¹[Γ(Nᵣ),P₀]}; where

γ⁻¹(m,n) is an inverse function of an incomplete gamma function γ(m,n)=∫₀ⁿt^{m-1}e^{-t}dt, and Γ(a)=∫₀^{∞}t^{a-1}e^{-t}dt is a standard gamma function. In this implementation, M=4 and P₀=0.9, and M is a threshold. When M is greater than this value, an algorithm procedure is triggered. In other implementations, there is no restriction (for example, M is a natural number between 1 and 100, and P₀ is any number between 0 and 1.0).

The distance parameter and the density parameter in the DBSCAN algorithm are denoted as ε and M respectively. The DBSCAN algorithm is executed to perform cluster classification on the samples in S. Statistics on the quantity C of clusters after the classification, and a quantity Nₜ of tags is calculated, where a calculation method is as follows:

Nₜ=┌log₂ C┐; where

┌⋅┐ denotes rounding up. In this way, S, N₀, Nᵣ, P₀, and M are inputted and the DB SCAN algorithm is executed, to calculate and output the quantity Nₜ of tags.

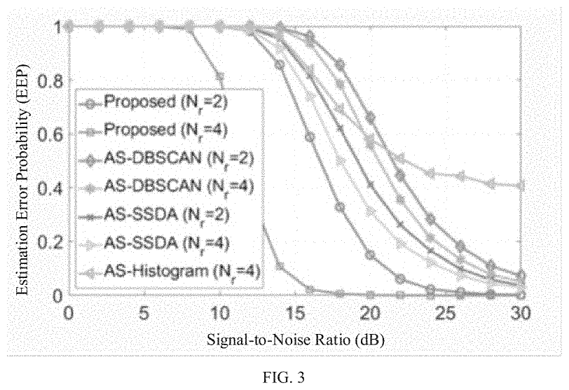

FIG. 3 is a simulation schematic diagram of comparison between an implementation of this application and an existing method. FIG. 3 shows estimation error probabilities (Estimation Error Probability, EEP) of a quantity of tags in the method (Proposed) proposed in this application, an antenna-selection-based DBSCAN method (AS-DBSCAN), an antenna-selection-based SSDA method (AS-SSDA), and an antenna-selection-based histogram method (AS-Histogram) in cases of different antenna quantities and different signal-to-noise ratios (SNR).

In the simulation environment of FIG. 3, the RFID system used conforms to the ISO18000-6C protocol standard. The quantity Nₜ of the receiving antennas is 2 and 4, and the quantity of tags is 3. It is assumed that a channel between each tag and the reader is an independent and identically distributed quasi-static Rayleigh fading channel. Estimation error probabilities (EEP) of the method proposed in this application are compared with those of the tag quantity estimation algorithms of AS-DB SCAN, AS-SSDA, and AS-Histogram in cases of different signal-to-noise ratios (SNR) and different antenna quantities. As can be seen from FIG. 3, the tag quantity estimation algorithm proposed in this application has a lower estimation error probability than the AS-DBSCAN, AS-SSDA, and AS-Histogram methods, and has more obvious performance advantages when the quantity Nₜ of antennas increases from 2 to 4.

This application also provides a processor-readable medium comprising a computer program running the above-described estimation method.

A person of ordinary skill in the art can understand that all or some of the steps in the foregoing method may be accomplished by hardware related to program instructions. The aforementioned program can be stored in a computer (processor)-readable storage medium. When the program is executed, the steps in the foregoing method embodiments are performed. The foregoing storage medium includes: various media that can store program code such as a ROM, a RAM, a magnetic disk, or an optical disk.

The technical features of the above embodiments may be performed in any combination. For ease of description, not all possible combinations of various technical features in the foregoing embodiments are described. However, as long as the combination of these technical features is not contradictory, they should be considered the scope described in this specification.

The foregoing embodiments are only to illustrate the technical ideas and features of this application, aiming to enable person familiar with this technology to understand the content of this application. The protection scope of this application is not limited thereto. All equivalent transformations or modifications made without departing from the spirit of this application should fall within the protection scope of this application.

1. An estimation method for an RFID tag quantity estimation system,
wherein the method comprises the following steps:
S0: obtaining multiple information blocks of multiple tag signal responses as reference data for tag quantity estimation;
S1: converting the received RF signals to baseband based on the down-conversion module;
S2: digitalizing the baseband signal and removing the carrier components in the digitalized baseband signal based on a carrier cancellation module;
S3: estimating the quantity of tags based on a tag quantity estimation module, and determining whether the quantity of tags is 0; and
if yes, returning to step S0; or
if not, performing step S31, wherein
sₖ(n)=[s_{1,k}(n),s_{2,k}(n), . . . ,s_{N}_{ᵣ}_{,k}(n)]^{T}, denoting a vector of a k^{th} tag symbol that is received by multiple antennas and in which the carrier signal is removed. The real part and the imaginary part of sₖ(n) are separately extracted. The real part and the imaginary part of the signal are sequentially stacked,
$${\overline{s}}_{k} ( n ) = [ \begin{matrix}ℛ \{ {s}_{k} ( n ) \} \\ 𝒯 \{ {s}_{k} ( n ) \}\end{matrix} ] ,$$
denoting a stacked signal vector, wherein [symbol] {●} denotes the operation of obtaining the real part of a complex number, and ℑ{●} denotes the operation of obtaining the imaginary part of a complex number,
S={s̅₁(n),s̅₂(n), . . . ,s̅_{K}(n)}, denoting a set of signal sample consisting of multiple received tag symbols,
the distance parameter ε in the DB SCAN algorithm is calculated through Nᵣ, N₀, and P₀, wherein a calculation formula is as follows:
ε=2\sqrt{N₀γ⁻¹[Γ(Nᵣ),P₀]}; where
γ⁻¹(m,n) is an inverse function of an incomplete gamma function γ(m,n)=∫₀ⁿt^{m-1}e^{-t}dt, Γ(a)=∫₀^{∞}t^{a-1}e^{-t}dt is a standard gamma function, P₀ denotes a probability specified by a user, Nᵣ denotes a quantity of receive antennas, N₀ denotes the thermal noise energy, and ε and M denote the distance parameter and the density parameter in the DBSCAN algorithm respectively,
the DBSCAN algorithm is executed to perform cluster classification on the samples in S, and
statistics on the quantity C of clusters after the classification, and a quantity of tags is calculated, wherein
a calculation method is Nₜ=┌log₂ C┐, wherein ┌⋅┐ denotes rounding up.

2. The estimation method according to claim 1, wherein M=4 and P₀=0.9.

3. An RFID tag quantity estimation system, wherein
the system comprises:
a down-conversion module for down-converting RF signals received by the receiving antenna to the baseband;
a carrier offset module for offsetting the carrier signal in the received signal which is sent by the transmitting antenna; and
a tag quantity estimation module for estimating the quantity of tags, wherein
the estimation method according to claim 1 is executed when the system runs.

4. A processor-readable medium, on which a computer program is stored, wherein the computer storage medium comprises a computer program, and the computer program running the estimation method according to claim 1.

5. An RFID tag quantity estimation system, wherein
the system comprises:
a down-conversion module for down-converting RF signals received by the receiving antenna to the baseband;
a carrier offset module for offsetting the carrier signal in the received signal which is sent by the transmitting antenna; and
a tag quantity estimation module for estimating the quantity of tags, wherein
the estimation method according to claim 2 is executed when the system runs.

6. A processor-readable medium, on which a computer program is stored, wherein the computer storage medium comprises a computer program, and the computer program running the estimation method according to claim 2.
